(19) United States
(12) Patent Application Publication
(10) Pub. No.: US 2003/0066858 A1
(43) Pub. Date: Apr. 10, 2003

(54) Control device for a drive motor in a stapler

(75) Inventor: Mats Holgersson, Hestra (SE)

Correspondence Address: HOWREY SIMON ARNOLD & WHITE LLP, 1299 PENNSYLVANIA AVE., NW, BOX 34, WASHINGTON, DC, 20004, US

(73) Assignee: Isaberg Rapid AB, Hestra (SE)

(21) Appl. No.: 10/065,324

(22) Filed: Oct. 3, 2002

(30) Foreign Application Priority Data
Oct. 4, 2001 (SE) 0103298-6

(51) Int. Cl. B27F 7/17

(52) U.S. Cl. 227/2; 227/131

(57) ABSTRACT

Control device (21) for controlling, by means of a microprocessor (22), an electrical drive motor (2) that is incorporated in a stapler (1) and whose drive shaft (9) drives a staple driver (13) in a forward and reverse motion that has a defined start point and a defined reversing point, and which staple driver drives, during its forward motion, a staple (15) into a workpiece (17), preferably a sheaf of paper, wherein the control device (21) comprises a sensor (23) that senses the rotational speed of the drive shaft (9) and the number of rotations it has completed from the start point, and transfers the sensed information to the microprocessor (22) which, in a known manner, analyzes the obtained information and generates a control signal that controls the supply of current to the drive motor (2), whereupon the rotational speed of the drive shaft is regulated.

### BACKGROUND OF INVENTION

1. Technical Area

The present invention relates to a control device for controlling, by means of a microprocessor, an electric drive motor that is incorporated in a stapler and whose drive shaft drives a staple driver in a forward and reverse motion. This motion has defined starting and reversing points or positions and, during its forward motion, the staple driver drives a staple into a work piece, preferably a sheaf of paper.

2. State of the Art

Control devices for drive motors in staplers are previously known. The forward- and reverse-moving staple driver is driven by a drive motor that has a drive shaft that either rotates in a defined direction and is connected to the staple driver via a cam arrangement, or by a drive motor whose drive shaft is reversed when the direction of the staple driver is reversed.

When the drive motor is reversed, the drive motor drives the staple driver in a first direction over a distance such that a staple is driven into the workpiece to be stapled. When the staple has been fully driven into the workpiece, the motor is reversed and the staple driver is driven in the opposite direction. In cases where the staple driver is driven via a cam arrangement, the forward and reverse motions are achieved by means of the cam arrangement in a manner that is known.

To reverse the motor, a control device is used in which a measuring element measures the current supplied to the motor and transfers the values obtained to a microprocessor. The microprocessor then analyzes the values in a known manner and, based on the analysis, controls the supply of current to the drive motor. In this way, the speed and direction of the drive motor drive shaft are controlled. A disadvantage of such a control device is that the measurements are made of the supplied current, which essentially varies only when the motor is under load, a condition that occurs when a staple is driven into a workpiece, and primarily at a terminal end of the motion when the staple is being pressed by the staple driver at the point of reversal. This entails that the motor control is delayed, and that the motor is thus loaded unnecessarily.

When the driver is driven via a cam arrangement, the motor is left uncontrolled, and the cam arrangement is therefore equipped with shock absorbing elements that absorb the increased forces that arise when a staple is fully driven into the workpiece, immediately before the driver is reversed. The disadvantage of such a device is that these shock absorbing elements can be difficult to install and also wear easily; as a result, they lose their efficacy, and this increases motor wear.

### SUMMARY OF INVENTION

A need thus exists for achieving control of the drive motor in such a way that it immediately senses the increased loads to which the motor is subjected, and in response thereto, correspondingly controls the supply of current to the motor.

In cases where the motor is reversed, a need also exists to reverse the motor at the right moment.

The present invention overcomes the above described problems utilizing a control device that, via a microprocessor, controls the electric drive motor of a staple driver in a stapling machine. The control device includes a sensor that senses the rotational speed of a drive shaft interconnected between the motor and staple driver, and the number or degree of rotation completed from the start point. This sensed information is then transferred to the microprocessor that analyzes the incoming information and generates a control signal that controls the supply of current to the drive motor based thereupon.

The invention is further characterized in that the supply of current is provided across a full bridge, whereupon the supply of current is controlled so that the speed and rotational direction of the drive shaft are regulated.

### BRIEF DESCRIPTION OF DRAWINGS

The accompanying Figures depict the following:

FIG. 1 shows a schematic cutaway view of a stapler equipped with a control device according to the invention, wherein the staple driver is positioned at its start point or position;

FIG. 2 shows a view corresponding to FIG. 1, but in which the staple driver is positioned at its reversing point; and

FIG. 3 presents a circuit diagram that shows, in detail, the components included in the control device, and their interconnections.

### DETAILED DESCRIPTION

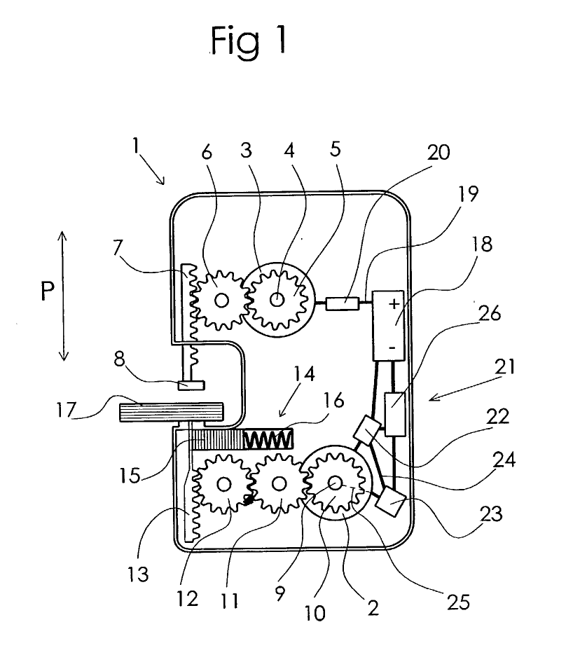

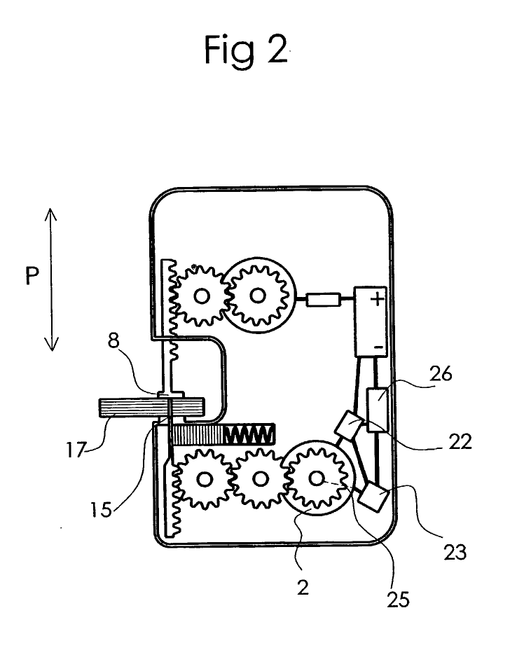

The invention shall hereafter be described with reference to the accompanying figures, in which FIGS. 1 and 2 schematically disclose a stapler 1 that has a first drive motor 2 and a second drive motor 3. The drive motor 3 has an outgoing shaft 4 to which is arranged a gearwheel 5. The gearwheel 5 drives, via an intermediate gear wheel 6, a gear rack 7 to which is arranged a bending die 8, whose function will be described below.

The first drive motor 2 bas a drive shaft 9 on which is arranged a gearwheel 10 that, via two intermediate gearwheels 11 and 12, drives a staple driver 13. The stapler 1 also contains a staple magazine 14 in which are stored staples 15 that are advanced by an elastic or biasing element 16. In the stapler 1, there is placed a workpiece 17 that is to be stapled, and which preferably consists of a sheaf of paper. The drive motors 2 and 3 are powered from a power supply 18, and the current is conducted through the wire 19 to the drive motor 3. A regulator 20 is arranged between the power supply 18 and the drive motor 3, the function of which regulator is to convert the current to the correct voltage for the drive motor 3. The drive motor 3 drives the bending die in an up-and-down motion, which is indicated by the double arrow P in FIG. 1. The functions of the drive motor 3 and the bending die 8 are not unique to the invention, and will therefore only briefly be described below.

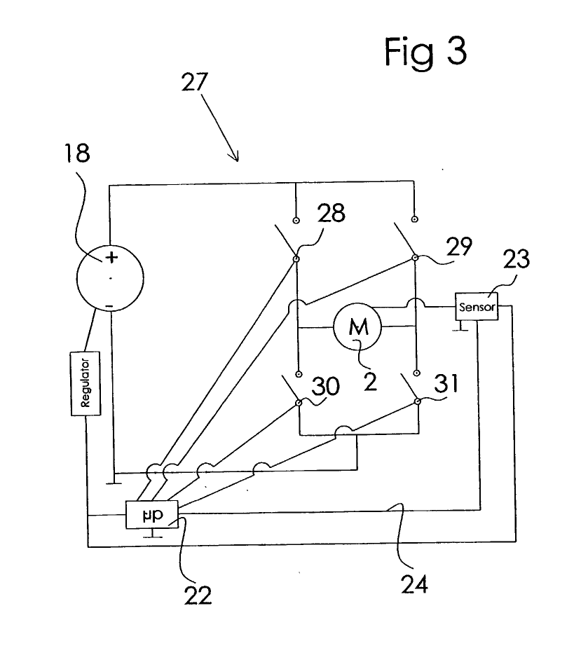

The supply of current to the drive motor 2 is regulated by a control arrangement or device 21 that includes a microprocessor 22 and a sensor 23. The microprocessor 22 is connected to the sensor 23 via the wire 24. The sensor 23 registers, by means of a sensing element 25, the rotational speed of the drive shaft 9 and the number of rotations it has completed from a start point. The microprocessor 22 and the sensor 23 are supplied with current from a regulator 26, which is connected to the power supply 18. FIG. 3 shows the design of the control device 21 in detail, and also how the supply of current to the drive motor is arranged. As FIG. 3 shows, the drive motor 2 is connected to a full bridge 27 that includes transistor switches 28, 29, 30 and 31. The sensor 23 is connected to the drive shaft 9 of the drive motor 2 by a sensing element 25 in a manner that is known to those skilled in this art and which is indicated by a broken line in FIGS. 1 and 2 where the sensor is shown connected to the microprocessor 22 via the wire 24. The microprocessor 22 is connected to the transistor switches 28-31.

The functions of the stapler and the control device will now be described with reference to FIGS. 1-3. When a workpiece 17 is to be stapled, it is placed in the stapler 1 in the manner shown in FIG. 1. The bending die 8 and the stapler 13 are in their start positions. The drive motor 3 drives the bending die 8 to the position shown in FIG. 2, in which position the bending die 8 lies in contact with the workpiece 17. The drive motor 2 is supplied with current from the power supply 18 across the transistor switch 28, with the circuit passing through the transistor switch 28, the drive motor 2 and the transistor switch 31 in a known manner. The drive motor 2 drives the staple driver 13 upward in the direction indicated by the double arrow P via the gearwheels 10, 11, and 12 (See FIGS. 1 and 2), and a staple 15 is pressed into the workpiece 17 as shown in FIG. 2. The sensor 23 registers both the rotational speed of the drive shaft 9, which speed decreases depending on the resistance that arises when the staple is driven into the workpiece, and the number of rotations completed from the start point. This information is transferred as obtained values to the microprocessor 22 via the wire 24. The microprocessor 22 analyzes the obtained values in a known manner and sends a control signal to the transistor switches 28 and 31, whereupon the supply of current to the drive motor 2 is regulated, thereby also regulating the rotational speed of the drive shaft 9. The staple driver 13 drives the staple 15 into the workpiece 17, and the staple 15 is fully driven into the workpiece 17 once the drive motor has completed a defined number of rotations at a position corresponding to that shown in FIG. 2. The sensor 23 that has been counting the number of rotations sends this information to the microprocessor 22. The microprocessor 22 then generates a control signal directing that the motor 2 be supplied with current via a circuit that passes through the transistor switch 29, the drive motor 2 and the transistor switch 30. Responsively, the motor 2 rotates in the opposite direction, and the staple driver 13 is thereby moved downward in the direction indicated by the double arrow P to the position shown in FIG. 1. The bending die 8 is thereafter also returned to its original position.

Because the microprocessor can be programmed with a defined program in a manner that is known to one skilled in the art, and because the sensor senses the speed of the drive shaft and the number of rotations it has completed, the drive motor 2 can be controlled with great precision. That is, so that its speed is slowed just before the staple driver 13 reaches its reversing point and, at the same time, the reversing process can be executed at a sharply delimited point, in that reversal occurs after a defined number or degree of rotation. The benefit derived is that the drive motor and the mechanical components involved in the stapler are thus spared exposure to unnecessary loads.

1. A control device (21) for controlling an electric stapler (1), said control device comprising:
a microprocessor (22), an electrical drive motor (2) that is incorporated in a stapler (1) and whose drive shaft (9) drives a staple driver (13) in a forward and reverse motion that has a defined start point and a defined reversing point, and which staple driver drives, during its forward motion, a staple (15) into a workpiece (17); and
said control device (21) further comprising a sensor (23) that senses the rotational speed of the drive shaft (9) and the degree of rotation it has completed from the start point, the control device then transfers the sensed information to the microprocessor (22) that analyzes the obtained information and generates a control signal that controls the supply of current to the drive motor (2) whereupon the rotational speed of the drive shaft is regulated.

2. The control device according to claim 1, wherein said workpiece is a sheaf of paper.

3. The control device according to claim 1, wherein the supply of current occurs across a full bridge (27), whereupon the supply of current is controlled so that the rotational direction and speed of the drive shaft (9) is regulated.

4. A method for controlling an electric stapler, said method comprising:
arranging a sensor for detecting positions of a staple driver of the electric stapler during execution of a stapling process; and
utilizing a microprocessor to analyze sensed position information about the staple driver; and
controlling positional changes of the staple driver based on the analysis of sensed position information.

5. The method for controlling an electric stapler according to claim 4, further comprising:
affecting positional changes of the staple driver by supplying controlled magnitudes of electrical current to a drive motor that is interconnected with the staple driver.

6. The method for controlling an electric stapler according to claim 4, further comprising:
affecting directional changes in movement of the staple driver by supplying oppositely sensed electrical current to a drive motor interconnected with the staple driver.

7. The method for controlling an electric stapler according to claim 6, further comprising:
utilizing a circuit internal to the electric stapler for switching the sense of the electrical current that is supplied to the drive motor that is interconnect with the staple driver.

8. The method for controlling an electric stapler according to claim 4, further comprising:
detecting positions of a staple driver on a real time basis.

9. The method for controlling an electric stapler according to claim 8, further comprising:
computing speed of travel of the staple driver based on a series of positions of the staple driver taken on a real time basis.

10. The method for controlling an electric stapler according to claim 4, further comprising:
driving said staple driver via an electric motor having a drive shaft rotatingly extending therefrom;
utilizing said sensor to detect and report rotational speed of the drive shaft.

11. The method for controlling an electric stapler according to claim 10, further comprising:
utilizing said sensor to detect and report rotational positions of the drive shaft.

12. The method for controlling an electric stapler according to claim 10, further comprising:
interconnecting the drive shaft with the staple driver via at least one toothed gear thereby establishing a directly proportional relationship between rotational characteristics of the drive shaft and translational characteristics of the staple driver.

13. The method for controlling an electric stapler according to claim 10, further comprising:
interconnecting the drive shaft with the staple driver via a plurality of interacting toothed gears thereby establishing a directly proportional relationship between rotational characteristics of the drive shaft and translational characteristics of the staple driver.

14. The method for controlling an electric stapler according to claim 10, further comprising:
reversing the direction of travel of the staple driver based on a sensed degree of rotation of the drive shaft correlating to a completed stapling action.

15. The method for controlling an electric stapler according to claim 10, further comprising:
slowing the travel speed of the staple driver upon approach to a completion position of a stapling action.

16. The method for controlling an electric stapler according to claim 4, further comprising:
reversing the direction of travel of the staple driver when a completion position of a stapling action is sensed and prior to a detrimental load being imposed upon the staple driver and an associated powering transmission.

17. The method for controlling an electric stapler according to claim 16, further comprising:
arranging the associated powering transmission to include at least a drive shaft extending from a driving electrical motor, a plurality of interacting toothed gears and an interacting toothed rack.

18. The method for controlling an electric stapler according to claim 17, further comprising:
arranging the toothed rack to be a part of the staple driver.
